(19) United States
(12) Patent Application Publication
(10) Pub. No.: US 2024/0316822 A1
(43) Pub. Date: Sep. 26, 2024

(54) MASONRY DRILLING TOOL, MASONRY DRILLING DEVICE, AND METHOD FOR DRILLING REINFORCED MASONRY

(71) Applicant: Hilti Aktiengesellschaft, Schaan (LI)

(72) Inventors: Serhey KHANDOZHKO, Buchs SG (CH); Dario BRALLA, Buchs (CH); Manuel KNOBEL, Ludesch (AT); Carsten PETERS, Sax (CH); Markus MEIERHOFER, Grabs (CH)

(21) Appl. No.: 18/578,848

(22) PCT Filed: Aug. 3, 2022
(86) PCT No.: PCT/EP2022/071782

§ 371 Date: Jan. 12, 2024

(30) Foreign Application Priority Data
Aug. 18, 2021 (EP) 21191908.9

(51) Int. Cl. B28D 1/14; B25D 17/02; B28D 7/02

(52) U.S. Cl. CPC B28D 1/146; B25D 17/02; B28D 7/02; B25D 2222/72; B25D 2250/141

(57) ABSTRACT

A masonry drilling tool for drilling reinforced masonry, in particular, reinforced concrete is provided, wherein the masonry drilling tool has a magnetizing device. A masonry drilling device and a method for drilling reinforced masonry is also provided.

The invention is based on a masonry drilling tool for drilling masonry, in particular reinforced concrete. The invention also relates to a masonry drilling device and to a method for drilling reinforced masonry with a masonry drilling tool.

During the drilling of reinforced masonry, breakages of the masonry drilling tool used frequently occur. Experience shows that there is a particularly high risk of breakage when the masonry drilling tool has a smaller diameter than a reinforcement to be severed, for example in the case of a masonry drilling tool with a diameter of 10 mm and a rebar to be severed with a diameter of 16 mm, and when the masonry drilling tool comes into contact with the reinforcement centrally.

Furthermore, the risk of breakage is often increased when drilling is carried out with a high drilling power, in particular with a high impact power. Although the risk of breakage can be partially decreased by reducing the drilling power while drilling the reinforcement, this results in correspondingly slower drilling progress.

Generally, conventional masonry drilling tools are subject to considerable wear when working on reinforced masonry, in particular while severing or drilling through a reinforcement, and this results in only short service lives for the drilling of reinforced masonry.

Therefore, it is an object of the present invention to specify a masonry drilling tool, a masonry drilling device and a method for drilling reinforced masonry with longer service lives when drilling reinforced masonry.

The object is achieved by a masonry drilling tool for drilling reinforced masonry, in particular reinforced concrete, wherein the masonry drilling tool has a magnetizing device.

The magnetizing device may be designed to magnetize the masonry drilling tool. In particular, a drill head of the masonry drilling tool may be able to be magnetized by the magnetizing device.

The masonry drilling tool may have a shaft and a drill head connected to the shaft at a connecting point.

The drill head may have one or more, for example three or four, cutting edges.

In conventional masonry drilling tools, when drilling in reinforced masonry, in particular while drilling through a reinforcement, breakages, for example in the form of splintering, of one or more cutting edges often occur. Breakages can also arise at the connecting point.

The invention is now based on the surprising observation that the risk of such breakages can be considerably decreased when the masonry drilling tool, in particular the drill head, is magnetized while drilling the reinforcement. Thus, during drilling, a magnetic field can be created in the region of the drill head. Thus, the masonry drilling tool according to the invention can have a particularly long service life, in particular when drilling reinforced masonry.

Usually, reinforcements are made from ferrous material. As a result, they are usually likewise able to be magnetized. As a result of the masonry drilling tool being magnetized according to the invention, ferrous chips detached from the reinforcement can thus be magnetized and magnetically attracted to the masonry drilling tool.

The ferrous chips can thus collect in the region of the masonry drilling tool, in particular in the region of the drill head. In-house studies have shown that the ferrous chips accumulated in this way decrease the risk of breakages. It is conceivable that, as a result of the ferrous chips, undesired load peaks, for example in the region of the contact zone between the drill head and reinforcement, can be damped. Thus, stress peaks of the masonry drilling tool can be minimized. In addition, it is also conceivable that the ferrous chips can generated further friction through the rotation of the masonry drilling tool, and so the reinforcement can be severed or drilled through more quickly and/or more reliably.

The effect can be particularly pronounced when drilling is carried out in a vertical direction, in particular upwardly. When drilling upwardly, the ferrous chips would normally fall out of the drilled hole under gravity. However, as a result of the magnetization, the ferrous chips can be retained at least partially and/or briefly in the region of the drill head.

The magnetizing device may have a permanent magnet. In particular, the magnetizing device may be in the form of a permanent magnet. The magnetic field required according to the invention can thus be provided continuously and without an additional external energy source.

Alternatively or additionally, the magnetizing device may also have a temporary magnet, in particular an electromagnet. Thus, the magnetic field according to the invention can be provided as required. For example, provision may be made for the magnetic field to be activated when the masonry drilling tool comes into contact with a reinforcement and/or while the reinforcement is being severed. During the drilling of the rest of the masonry, which is not reinforced, it is possible, however, for the magnetic field to be deactivated.

In addition, a temporary magnet can also generate a magnetic field in the event of relatively high temperatures, for example of temperatures greater than 200° C. In this case, the temperature can relate in particular to a temperature measured at the drill head.

The magnetizing device may be arranged and/or formed in the region of the drill head, for example on the shaft, of the masonry drilling tool. Alternatively or additionally, it is also possible for a part of the masonry drilling tool, for example a portion of the shaft, to be configured as a magnetizing device, in particular in the form of a magnet.

It is also conceivable for the magnetizing device to be configured as a separate part of the masonry drilling tool. It may for example be arranged around the rest of the masonry drilling tool, i.e. in particular around the shaft and/or around the drill head. To this end, the magnetizing device may be annular.

It is also conceivable for the masonry drilling tool to be in the form of a hammer drill.

In hammer drills, it is conventional for them to have a drill head which is connected to the shaft of the masonry drilling tool via a connecting point.

The connecting point may be produced by brazing and/or welding.

Furthermore, the drill head of hammer drills usually has one or more cutting edges, which are formed at least substantially in a cuboid shape and/or project at least partially from the rest of the drill head.

Such a hammer drill thus entails in principle the risks, described at the beginning, of breakages, in particular the risk, described at the beginning, of splintering and the risk of breakage of the connecting point, and so the invention can have a particularly advantageous effect in such a hammer drill.

It is also conceivable for the masonry drilling tool, in particular a drill head of the masonry drilling tool, to exhibit cobalt and/or nickel. These elements and/or alloys formed with these elements may be magnetic and/or able to be magnetized, such that the magnetic field can spread and/or form better in the region of the drill head.

It is particularly advantageous in this case when the drill head exhibits a hard metal exhibiting cobalt and/or nickel. The drill head may in particular be formed from such a hard metal. As a result of this, too, the service life or lifetime of the masonry drilling tool can be extended further.

It is also conceivable here for the masonry drilling tool to have more than one cutting edge, in particular more than two cutting edges, for example four or six cutting edges. As a result of such an increased number of cutting edges, sticking of the masonry drilling tool at and/or in the reinforcement can be reduced, and so the effective risk of breakage can be decreased further and the service life of the masonry drilling tool can be extended further.

Alternatively or additionally, it is also conceivable for the masonry drilling tool to be in the form of a suction drilling tool and/or of a hollow drilling tool. Then, a suction device can be connected directly to the masonry drilling tool.

The scope of the invention also covers a masonry drilling device comprising a power drill and a masonry drilling tool that is able to be driven by the power drill, wherein the masonry drilling device has a magnetizing device for magnetizing the masonry drilling tool.

In accordance with the above-described concept according to the invention, the masonry drilling device can thus comprise the magnetizing device. The magnetizing device may generate a magnetic field, which can form and/or spread along and/or in the region of the masonry drilling tool. The masonry drilling tool, in particular its drill head and/or a region bordering the drill head, may be able to be magnetized by the magnetizing device.

The masonry drilling device may be and/or comprise a construction robot, in particular a drilling construction robot. The masonry drilling device may, to this end, have at least one arm. The power drill may then be arranged and/or formed on the arm. The arm may be multiaxial. It may have at least three degrees of freedom, preferably at least six degrees of freedom.

The construction robot may also have a lifting device. The lifting device may be configured to displace the power drill and/or the arm in a vertical direction. The masonry drilling device may be configured to drill in a vertical direction, in particular upwardly in a vertical direction. The masonry drilling device may thus be configured for example to drill into a ceiling.

It may alternatively or additionally also be configured to drill in a horizontal direction, for example to drill into a wall.

It is also conceivable for the masonry drilling device to have a suction device. The suction device may be controllable by the masonry drilling device. In particular, it may be able to be switched on, switched off and/or have its power regulated by the masonry drilling device.

The suction device may be configured to extract drilling dust by suction from a drilled hole formed in the masonry by the masonry drilling tool.

Particularly preferably, the masonry drilling device may be configured to activate and/or deactivate the suction device depending on the type of the substrate being worked in each case. It is conceivable for example for the suction device to be activated and/or to work with high power when drilling through non-reinforced masonry. While severing a reinforcement, the suction device may is deactivated and/or works with reduced power.

It is also possible for the masonry drilling device to having a blowing device. Particularly preferably, the blowing device may be part of the suction device, for example by the suction device being equipped with a blowing function. Thus, it is not just possible not to extract the drilling dust by extraction where required. Rather, such a blowing device makes it possible to blow drilling dust that has previously been extracted by suction and/or particles stored externally, for example other drilling dust, into the drilled hole. Thus, the quantity of particles, in particular the quantity of drilling dust, can be increased further while the reinforcement is being drilled.

The suction device may be controllable by the masonry drilling device. In particular, it may be able to be switched on, switched off and/or have its power regulated by the masonry drilling device.

In one class of embodiments of the invention, the magnetizing device may be formed and/or arranged on the suction device. Thus, a magnetic field can be made available. The advantages according to the invention can be realized. These may be realizable in particular independently of the type of masonry drilling tool that is used. Thus, service lives even of conventional masonry drilling tools, for example of conventional hammer drills, can be considerably extended by means of the masonry drilling device according to the invention when working on reinforced masonry.

In this case, the magnetizing device may have a permanent magnet and/or a temporary magnet, in particular an electromagnet. These kinds of magnet can realize the advantages described above in connection with the masonry drilling tool, without a particular configuration of the masonry drilling tool to be used being necessary.

Alternatively or additionally, it is also conceivable for the masonry drilling device to have a masonry drilling tool having the above-described features and advantages. The magnetizing device of the masonry drilling tool may then form the magnetizing device of the masonry drilling device.

It is also conceivable for the masonry drilling device to have a drilling direction identification device, a substrate identification device and/or a drilling progress identification device.

Thus, the masonry drilling device may be configured to use the drilling direction identification device to detect a drilling direction. In particular, it may be designed to detect whether drilling is being effected in a vertical or at least substantially vertical direction. It may particularly preferably be designed to detect whether drilling is being effected vertically upwardly or at least substantially vertically upwardly.

The masonry drilling device may be configured to use the substrate identification device to detect a substrate to be worked, in particular a reinforcement and/or non-reinforce masonry.

It may also be configured to use the drilling progress identification device to detect drilling progress. The drilling progress may be able to be measured, and thus to be detected, for example on the basis of the drilling speed.

The masonry drilling device may be operable in at least two drilling modes. One drilling mode may be a reinforcement drilling mode. The reinforcement drilling mode may be designed to sever a reinforcement. The masonry drilling device may furthermore have a non-reinforcement drilling mode. The non-reinforcement drilling mode may be designed for drilling non-reinforced masonry, for example concrete away from reinforcements.

In the reinforcement drilling mode, the masonry drilling device may be designed for example to deactivate the suction device and/or to operate the latter with reduced power. In the reinforcement drilling mode, provision may also be made to activate the magnetizing device and in particular to generate the magnetic field.

In the non-reinforcement drilling mode, provision may be made to deactivate the magnetizing device and thus to deactivate the magnetic field while drilling non-reinforced masonry. In the non-reinforcement drilling mode, provision may also be made to activate the suction device and/or to operate it with regular and/or increased power.

The masonry drilling device may be designed, depending on the type of the substrate to be drilled in each case, to automatically choose between the reinforcement drilling mode and the non-reinforcement drilling mode, in particular to switch over between these two drilling modes. To this end, the type of substrate may be determined and/or be able to be determined using the substrate identification device.

It is also conceivable for the masonry drilling device to be designed to select the reinforcement drilling mode or, alternatively, only to select it when drilling is effected upwardly in a vertical or substantially vertical direction.

Alternatively or additionally, it also be designed to activate the magnetic field, in particular in the case of a temporary magnet, or, alternatively, only to activate it when drilling is effected into a reinforcement and, particularly preferably, when drilling is additionally effected upwardly in a vertical or substantially vertical direction.

The scope of the invention also covers a method for drilling reinforced masonry with a masonry drilling tool, in particular a masonry drilling tool according to the invention, wherein, during drilling, the masonry drilling tool, in particular a drill head of the masonry drilling tool, is magnetic and/or magnetized.

By way of this method according to the invention, too, it is thus possible for the abovementioned, surprising finding according to the invention and its advantageous effects of magnetization during the drilling of reinforced masonry to be exploited. The risk of a breakage of the masonry drilling tool can thus be reduced. The service life of the masonry drilling tool can thus be considerably extended.

The method can be applied particularly advantageously when drilling is effected into a ceiling and/or upwardly in a vertical or substantially vertical direction. In this case, the ferrous chips of a reinforcement would usually fall out of the drilled hole created during drilling under gravity. According to the invention, it is possible, by contrast, for these ferrous chips to be retained at least partially and/or temporarily in the drilled hole and in particular in the region of the drill head.

A drilling direction, a substrate type and/or drilling progress can be detected, in particular during the drilling of the reinforced masonry. For example, a location of the masonry drilling tool and/or of a masonry drilling device can be determined, vibrations can be evaluated and/or a drilling speed can be measured.

It is thus possible to monitor the drilling direction, the type of substrate and/or the drilling progress. It is possible, for example, to derive therefrom whether drilling is being effected for example upwardly and/or into a ceiling and/or whether a reinforcement or non-reinforced masonry, in particular concrete, is being drilled. The magnetizing device can then be activated, deactivated and/or have its power regulated as required. For example, it can be activated when a reinforcement is reached and/or being severed. During the drilling of masonry, i.e. in particular away from a reinforcement, the magnetizing device can be deactivated. Likewise, the suction device can be activated, deactivated and/or have its power regulated as required. This can take place analogously to the control of the magnetizing device also for the control of the suction device.

This may be advantageous in particular when, for drilling, use is made of a masonry drilling device which is in the form of and/or has a drilling construction robot, since in these, the abovementioned original risk of breakage can frequently be increased compared with human users of a masonry drilling device.

Further features and advantages of the invention emerge from the following detailed description of exemplary embodiments of the invention, with reference to the figures of the drawing, which shows details essential to the invention, and from the claims. The features shown there are not necessarily to be understood as true to scale and are shown in such a way that the special features according to the invention can be made clearly visible. The various features can be implemented individually in their own right or collectively in any combinations in variants of the invention.

Exemplary embodiments of the invention are shown in the schematic drawing and explained in more detail in the following description.

In the drawing:

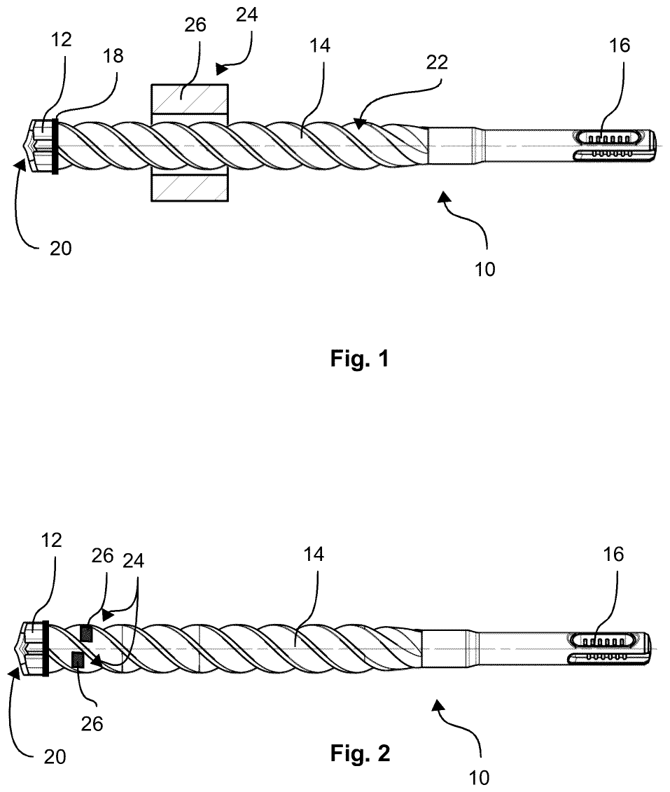

FIG. 1 shows a schematic side view of a first masonry drilling tool with a magnetizing device;

FIG. 2 shows a schematic side view of a second masonry drilling tool with a second magnetizing device:

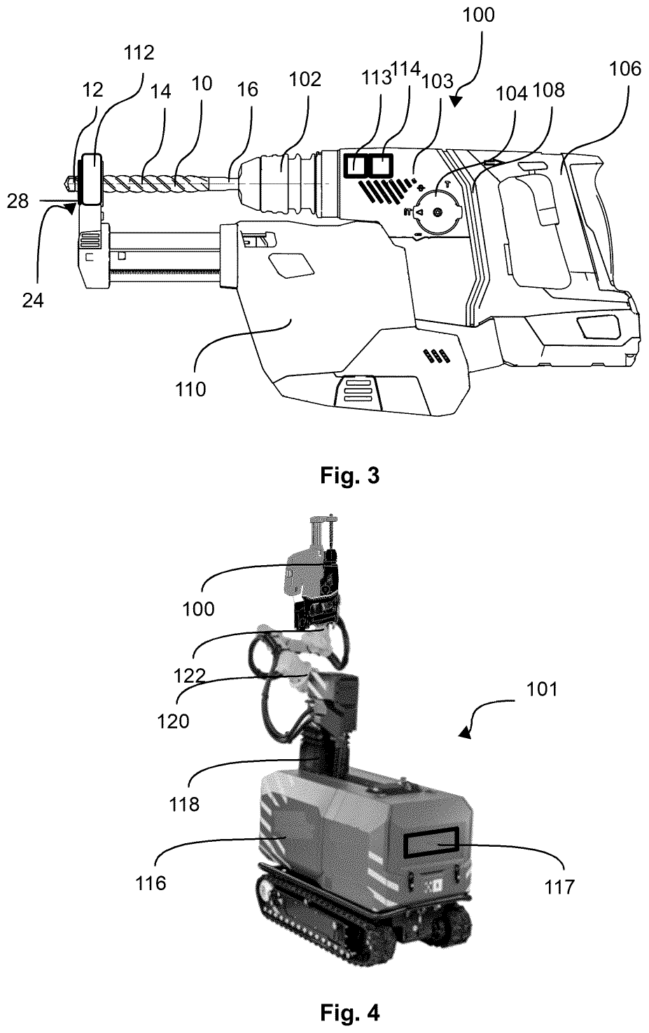

FIG. 3 shows a schematic side view of a masonry drilling device with a suction device and a magnetizing device arranged thereon:

FIG. 4 shows a schematic, perspective illustration of a masonry drilling device in the form of a drilling construction robot; and

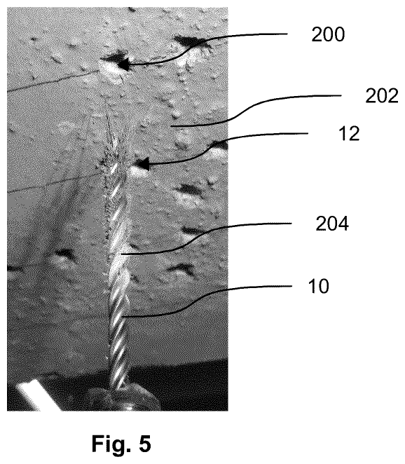

FIG. 5 shows a photographic depiction of a masonry drilling tool after the drilling of reinforced masonry.

In order to make it easier to understand the invention, the same reference signs are used in each case for identical or functionally corresponding elements in the following description of the figures.

FIG. 1 shows a masonry drilling tool 10 having a drill head 12, a shaft 14 and a shank 16.

The masonry drilling tool 10 is in the form of a hammer drill.

The drill head 12 has been brazed to the shaft 14 at a connecting point 18. Alternatively, it is also conceivable for the drill head 12 to have been welded to the shaft 14 at the connecting point 18.

The drill head 12 has four cutting edges 20, which are cruciform overall. The drill head 12 is made from a hard metal, for example from a cobalt- and/or nickel-containing tungsten carbide.

The shaft 14 has a transport structure 22. The transport structure 22 is configured to transport away drilling dust, chips or the like. To this end, the transport structure 22 has an outer spiral extending in particular helically. The transport structure 22 may be of single-start or multi-start form.

The shank 16 can have a standardized shape: for example, it can have a shape that is usually designated “SDS-plus”.

Furthermore, the masonry drilling tool 10 has a magnetizing device 24. The magnetizing device 24 is annular. It surrounds the shaft 14.

The magnetizing device 24 has a permanent magnet 26.

The permanent magnet 26 thus generates a magnetic field, which spreads in the region of the rest of the masonry drilling tool 10, for example along the shaft 14 and particularly preferably in the region of the drill head 12.

Thus, there is a magnetic field in the region of the drill head 12, in particular in the region of the cutting edges 20. The magnetic field thereof has such a strength that, during drilling with the masonry drilling tool 10, ferrous chips that arise in a reinforcement of the reinforced masonry to be drilled can be magnetically attracted by the masonry drilling tool 10. The ferrous chips can thus be collected, in particular in the region of the drill head 12.

FIG. 2 shows a further masonry drilling tool 10, which, unless described otherwise below; corresponds to the above-described exemplary embodiment of the masonry drilling tool 10 according to FIG. 1.

In contrast to the above-described exemplary embodiments, in this masonry drilling tool 10, the magnetizing device 24 is not an annular separate part in particular surrounding the masonry drilling tool 10.

Rather, the magnetizing device 24 is in the form of a plurality of permanent magnets 26 which are arranged on the shaft 14.

In particular, the permanent magnets 26 are arranged in an end region of the shaft 14 facing the drill head 12. Thus, the permanent magnets 26 are arranged in the vicinity of the drill head 12. The can, for example, be adhesively bonded, brazed and/or welded to the shaft 14.

It is also conceivable for the shaft 14 to have at least one region with a magnetizable material. It is then possible for the permanent magnets 26 to also be formed in that this region of the shaft 14 is magnetized.

It is thus possible in this embodiment too for the magnetizing device 24 to generate a magnetic field, in particular by means of the permanent magnets 26. The magnetic field can be available permanently in the region of the drill head 12, in particular in the region of its cutting edges 20.

FIG. 3 shows a masonry drilling device 100. The masonry drilling device 100 comprises a power drill 103. This is in the form of a hammer drill. It has a tool holder 102, in which a masonry drilling tool 10 is received. The masonry drilling device 100 is configured to drill reinforced masonry. It has an operating mode selector switch 104. Different operating modes can be selected using the operating mode selector switch 104. In particular, an operating mode for hammer-drilling, i.e. for impact drilling, is available.

The masonry drilling device 100 also has a handle region 106. The handle region 106 is configured for the manual and/or mechanical holding of the masonry drilling device 100.

Formed between the handle region 106 and the rest of the masonry drilling device 100 is a vibration damper 108, which is designed to minimize any transmission of vibrations from the rest of the masonry drilling apparatus 100 to the handle region 106.

The drilling device 100 also has a suction device 110. The suction device 110 is arranged, in particular releasably, on the masonry drilling device 100.

The suction device 110 has a suction head 112. The suction head 112 annularly surrounds the masonry drilling tool 10 received in the tool holder 102.

The suction head 112 is configured to extract by suction drilling dust created by the masonry drilling tool 10 while drilling into masonry, in particular into reinforced masonry.

The suction head 112 is arranged telescopically on the rest of the suction device 110. Thus, the section head 112 can butt against a surface of masonry to be drilled while the masonry drilling tool 10 penetrates into the masonry to be drilled.

Furthermore, a magnetizing device 24 is formed on the suction head 112 annularly surrounding the masonry drilling tool 10.

It has an annular electromagnet 28. The electromagnet 28 is able to be supplied with electrical energy via the suction device 110. Preferably, the suction device 110 can itself be able to be supplied with electrical energy by the masonry drilling device 100.

In this way, the masonry drilling device 100 is configured such that the electromagnet 28 and thus a magnetic field generated thereby is able to be activated, to be deactivated or to have its power controlled.

The masonry drilling device 100 has a drilling direction identification device 113 and a substrate identification device 114. The drilling direction identification device 113 and the substrate identification device 114 are illustrated only schematically in FIG. 3 for reasons of illustration.

The drilling direction identification device 113 is configured to detect a drilling direction. In particular, it is designed to detect whether drilling is being effected in a vertical or substantially vertical direction and, particularly preferably, whether drilling is being effected upwardly. To this end, the drilling direction identification device 113 may have a position sensor.

The substrate identification device 114 is configured to sense and/or evaluate vibrations of the tool 102. It may also be designed to use these vibrations to detect the type of substrate being worked in each case. Thus, it may be designed to distinguish between working on a reinforcement and on non-reinforced masonry.

By means of the drilling direction identification device 113 and the substrate identification device 114, the masonry drilling device 100, in particular when hammer-drilling has been selected as the operating mode, is designed to select automatically between a reinforcement drilling mode and a non-reinforcement drilling mode. Depending on the drilling mode, in particular the electromagnet 28 is activated, deactivated and/or has its power regulated. Preferably, the suction device 110 can also be controlled by the masonry drilling device 100 analogously to the electromagnet 28.

FIG. 4 shows a masonry drilling device 101. The masonry drilling device 101 is in the form of a drilling construction robot. It has a mobile platform 116. The mobile platform 116 is in the form for example of a track vehicle. The mobile platform 116 may be remote-controllable, partially autonomously controllable and/or fully autonomously controllable.

Moreover, the mobile platform 116 has a control unit 117 illustrated only schematically in FIG. 4. The control unit 117 is in the form of a computer unit and is designed to control all the functions of the masonry drilling device 101, in particular including its drilling functions.

Arranged on the mobile platform 116 is a lifting device 118, by way of which an arm 120 is additionally displaceable in a vertical direction. The arm 120 has six degrees of freedom.

At its free end, the arm 120 has a power tool holder 122. Accommodated in the power tool holder 122 is a masonry drilling device 100. The masonry drilling device 100 corresponds to the embodiment described above in conjunction with FIG. 3.

Via a control interface (not illustrated in FIG. 4) integrated into the power tool holder 122, the masonry drilling device 100 is also controllable by the control unit 117.

Overall, the masonry drilling device 101 is thus designed to drill masonry, in particular reinforced masonry, in a horizontal and/or vertical direction and thus to drill into walls and/or ceilings. Preferably, it is also designed to drill into floors. The walls and/or the ceilings may be made from reinforced masonry, for example reinforced concrete. It should particularly be noted that the masonry drilling device 101 is thus designed to drill in a vertical or a substantially vertical direction and in particular upwardly.

On the basis of FIG. 4, a method for drilling reinforced masonry with the masonry drilling device 101 will be described in more detail in the following text.

In the example, it is assumed that a 10-mm drilled hole is intended to be drilled into a ceiling made from reinforced concrete. In this regard, drilling is intended to be effected vertically upwardly into the reinforced concrete. The reinforcement of the reinforced concrete consists for example of ferrous rebars each with a diameter of 16 mm.

To this end, the masonry drilling device 101 first of all directs its masonry drilling device 100 and thus the masonry drilling tool 10 (FIG. 3) accommodated therein vertically upwardly.

Subsequently, the drilling operation is started.

During drilling, the masonry drilling device 100 uses the substrate identification device 114 (FIG. 3) to monitor the type of substrate being worked in each case.

As long as concrete is established as the substrate type, the masonry drilling device 100 works in the non-reinforcement drilling mode. In particular, the suction device 110 (FIG. 3) is operated with high power and the magnetizing device 24 (FIG. 3) remains deactivated.

However, as soon as a reinforcement is detected as the substrate type, the masonry drilling device 100 switches over to the reinforcement drilling mode. In particular, to this end, the power of the suction device 110 is reduced and the magnetizing device 24 is activated.

As soon as the reinforcement has been drilled through fully, the device then switches over into the non-reinforcement drilling mode again.

It is alternatively or additionally conceivable for the monitoring of the substrate type and/or further monitoring of further drilling parameters, for example drilling progress, to be effected by the control unit 117. Preferably, the selection and optionally the switching of the drilling mode can be effected by the control unit 117.

The drilling progress can be measured for example by monitoring the movements of the lifting device 118 and/or of the arm 120.

FIG. 5 shows a photographic depiction of a masonry drilling tool 10 after a drilled hole 200 has been drilled in reinforced masonry 202. The reinforced masonry 202 forms a ceiling of a building. The drilled hole 200 is thus formed vertically upwardly.

The masonry drilling tool 10 has been magnetized. In particular, it corresponds to the embodiment of the masonry drilling tool 10 that is described in conjunction with FIG. 2.

It is apparent that non-magnetic drilling dust 204 is located along the shaft 14, in particular along the transport structure 22 (FIG. 1).

It is also apparent that ferrous chips 206 are stuck to the masonry drilling tool 10, in particular on account of the magnetization of the masonry drilling tool 10.

The ferrous chips 206 are located in this case in particular in the region of the drill head 12 of the masonry drilling tool 10. In the illustration according to FIG. 5, the drill head 12 is largely concealed by the ferrous chips 206.

In-house studies have shown that, for different masonry drilling tools 10, in particular when drilling in ceilings into reinforced concrete, including drilling through reinforcements located in the reinforced concrete, the risk of breakage mentioned at the beginning can be approximately halved by the described measures and/or devices. Accordingly, the service lives of the masonry drilling tools 10 can be approximately doubled without a reduction in the drilling power, in particular the impact power, when coming into contact with the reinforcement.

### LIST OF REFERENCE SIGNS

10 Masonry drilling tool
12 Drill head
14 Shaft
16 Shank
18 Connecting point
20 Cutting edges
22 Transport structure
24 Magnetizing device
26 Permanent magnet
100 Masonry drilling device
101 Masonry drilling device
102 Tool holder
103 Power drill
104 Operating mode selector switch
106 Handle region
108 Vibration damper
110 Suction device
112 Suction head
113 Drilling direction identification device
114 Substrate identification device
116 Mobile platform
117 Control unit
118 Lifting device
120 Arm
122 Power tool holder
200 Drilled hole
202 Masonry
204 Drilling dust
206 Chips

1. A masonry drilling tool for drilling reinforced masonry,
wherein the masonry drilling tool has a magnetizing device.

2. The masonry drilling tool as claimed in claim 1, wherein the magnetizing device has a permanent magnet.

3. The masonry drilling tool as claimed in claim 1, wherein the magnetizing device has a temporary magnet, in particular an electromagnet.

4. The masonry drilling tool as claimed in claim 1, wherein the masonry drilling tool is in the form of a hammer drill.

5. The masonry drilling tool as claimed in claim 1, wherein the masonry drilling tool exhibits cobalt and/or nickel.

6. A masonry drilling device, comprising a power drill and a masonry drilling tool that is able to be driven by the power drill
wherein the masonry drilling device has a magnetizing device for magnetizing the masonry drilling tool.

7. The masonry drilling device as claimed in claim 6, wherein the masonry drilling device has a suction device.

8. The masonry drilling device as claimed in claim 7, wherein the magnetizing device is formed and/or arranged on the suction device.

9. The masonry drilling device as claimed in claim 6, wherein the magnetizing device has a permanent magnet.

10. The masonry drilling device as claimed in claim 6, wherein the magnetizing device has a temporary magnet.

11. The masonry drilling device as claimed in claim 6, wherein the masonry drilling device has a masonry drilling tool.

12. The masonry drilling device as claimed in claim 6, wherein the masonry drilling device has a drilling direction identification device, a substrate identification device and/or a drilling progress identification device.

13. A method for drilling reinforced masonry with a masonry drilling tool comprising a magnetizing device, wherein, during drilling, the masonry drilling tool is magnetic and/or magnetized.

14. The method as claimed in claim 13, wherein drilling is effected into a ceiling and/or in a vertically upward direction.

15. The method as claimed in claim 13, the method including detecting a drilling direction, a type of substrate and/or drilling progress.

16. The masonry drilling tool as claimed in claim 3, wherein the temporary magnet is an electromagnet.

17. The masonry drilling tool as claimed in claim 5, wherein a drill head of the masonry drilling tool exhibits cobalt and/or nickel.

18. The masonry drilling device as claimed in claim 10, wherein the temporary magnet is an electromagnet.

19. The method of claim 13, wherein, during drilling, the drill head of the masonry drilling tool is magnetic and/or magnetized.

20. The method as claimed in claim 15, including detecting the drilling direction, the type of substrate and/or drilling progress, during the drilling of the reinforced masonry.
